(19) United States
(12) Patent Application Publication
(10) Pub. No.: US 2025/0313274 A1
(43) Pub. Date: Oct. 9, 2025

(54) FRONT SIDE VEHICLE BODY FOR A VEHICLE

(71) Applicants: HYUNDAI MOTOR COMPANY, Seoul (KR); KIA CORPORATION, Seoul (KR)

(72) Inventors: Jong Gwan Yun, Busan (KR); Yong Dok An, Anyang-si (KR); Do Hoi Kim, Sejong-si (KR); Mun Soo Cha, Suwon-si (KR)

(73) Assignees: HYUNDAI MOTOR COMPANY, Seoul (KR); KIA CORPORATION, Seoul (KR)

(21) Appl. No.: 18/816,525

(22) Filed: Aug. 27, 2024

(30) Foreign Application Priority Data
Apr. 9, 2024 (KR) 10-2024-0048189

(51) Int. Cl. B62D 25/08

(52) U.S. Cl. CPC B62D 25/088; B62D 25/085

(57) ABSTRACT

A front side vehicle body for a vehicle includes: a front side member extending in a longitudinal direction of a vehicle, a shock absorber housing disposed between a front end and a rear end of the front side member and connected to the front side member, and an A-pillar connected to the rear end of the front side member. In particular, the front side member, the shock absorber housing, and the A-pillar are integrated, and a plurality of opening portions is disposed in an upward/downward direction in the front side member and opened in opposite directions or the same direction.

### CROSS-REFERENCE TO RELATED APPLICATION

The present application claims priority to Korean Patent Application No. 10-2024-0048189, filed on Apr. 9, 2024, the entire contents of which are incorporated herein by reference.

### BACKGROUND

### Field

The present disclosure relates to a front side vehicle body that constitutes a front side of a vehicle body of a vehicle.

### Description of the Related Art

A front side vehicle body for a vehicle may be configured by assembling fifty or more components. In order to reduce the weight of the vehicle, methods are being studied to minimize the number of components of the front side vehicle body for the vehicle.

In case that the front side vehicle body for a vehicle becomes lightweight, the rigidity may deteriorate. Therefore, it is desired for a front side vehicle body to satisfy the minimum rigidity requirement while reducing its weight.

### SUMMARY

The present disclosure has been made keeping in mind the above problems occurring in the related art, and the present disclosure provides a front side vehicle body for a vehicle that may reduce the weight of the front side vehicle body and satisfy rigidity capable of protecting an occupant in the event of a frontal collision of the vehicle.

According to one aspect of the present disclosure, a front side vehicle body for a vehicle includes: a front side member extending in a longitudinal direction of a vehicle; a shock absorber housing disposed between a front end and a rear end of the front side member and connected to the front side member; and an A-pillar connected to the rear end of the front side member, in which the front side member, the shock absorber housing, and the A-pillar are integrated. In addition, a plurality of portions each forming an opening (hereinafter “opening portions”) may be disposed in an upward/downward direction in the front side member and opened in opposite directions or the same direction.

The plurality of opening portions may have the same opening depth.

The opening portions may include: at least one first opening portions, which are opened toward the inside of the vehicle, and at least one second opening portions opened toward the outside of the vehicle.

In one embodiment, the second opening portion may be formed to be disposed below the first opening portion.

In one embodiment, at least one of the horizontal or vertical rib, which extends toward the inside or outside of the vehicle, may be formed in at least one opening portion of the plurality of opening portions and divide the at least one opening portion into a plurality of spaces.

When the horizontal and the vertical rib are formed in the at least one opening portion, a diagonal rib is provided in the at least one opening portion and configured to pass through an intersection point of the horizontal rib and the vertical rib and may divide the spaces defined by the horizontal rib and the vertical rib.

The horizontal rib and the vertical rib may define a space at a front end of the front side member on which the shock absorber housing is disposed, and the horizontal rib, the vertical rib, and the diagonal rib may define a space at a rear end of the front side member.

The opening portions may include one or more of first opening portions, which are opened toward the inside of the vehicle, and one or more second opening portions opened toward the outside of the vehicle. The vertical rib extending toward the inside of the vehicle may be formed in the first opening portion, and the horizontal and vertical ribs extending toward the outside of the vehicle may be formed in the second opening portion.

An end of the shock absorber housing connected to the front side member may be connected to an upper end of the opening portion.

In another embodiment, a sub-frame mounting part, to which a sub-frame is coupled, may be formed on the front side member.

The sub-frame mounting part may be formed on the same plane as the vertical rib formed at the front end of the front side member.

The opening portions may include: a first opening portion opened toward the inside of the vehicle; and a second opening portion opened toward the outside of the vehicle, and the first opening portion and the second opening portion may be disposed at left and right sides of the front side vehicle body.

According to the present disclosure, it is possible to provide the front side vehicle body for a vehicle in which the front side member, the shock absorber housing, and the A-pillar are integrated, such that the weight of the front side vehicle body for a vehicle is reduced.

Further, because the opening portion is formed in the front side member, the front side member may be uniformly deformed by collapse or crushing caused by a frontal collision of the vehicle, such that collision energy may be smoothly absorbed, which is advantageous in safely protecting the occupant.

### BRIEF DESCRIPTION OF THE DRAWINGS

FIGS. 1 and 2 are perspective views of a front side vehicle body for a vehicle according to an embodiment of the present disclosure.

FIG. 3 is a front view illustrating the front side vehicle body for a vehicle according to the present disclosure and illustrating a cross-section of a front side member having an opening portion.

FIGS. 4 to 6 are views illustrating cross-sectional shapes of opening portions of a front side member according to several embodiments.

FIG. 7 is a view illustrating an inner surface of the front side vehicle body for a vehicle according to an embodiment of the present disclosure.

FIG. 8 is a view illustrating a state in which an end of the opening portion of the front side member and an end of a shock absorber are connected according to an embodiment of the present disclosure.

FIG. 9 is a view illustrating a positional relationship between a sub-frame mounting part and a vertical rib according to an embodiment of the present disclosure.

### DETAILED DESCRIPTION

Hereinafter, embodiments of the present disclosure are described in detail with reference to the accompanying drawings. The same or similar constituent elements are assigned with the same reference numerals regardless of reference numerals, and the repetitive description thereof are omitted.

In the description of the embodiments disclosed in the present disclosure, the specific descriptions of publicly known related technologies has been omitted when it is determined that the specific descriptions may obscure the subject matter of the embodiments disclosed in the present disclosure. In addition, it should be interpreted that the accompanying drawings are provided only to allow those having ordinary skill in the art to easily understand the embodiments of the present disclosure, and the technical spirit disclosed in the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions. When a component, device, element, or the like of the present disclosure is described as having a purpose or performing an operation, function, or the like, the component, device, or element should be considered herein as being “configured to” meet that purpose or to perform that operation or function.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

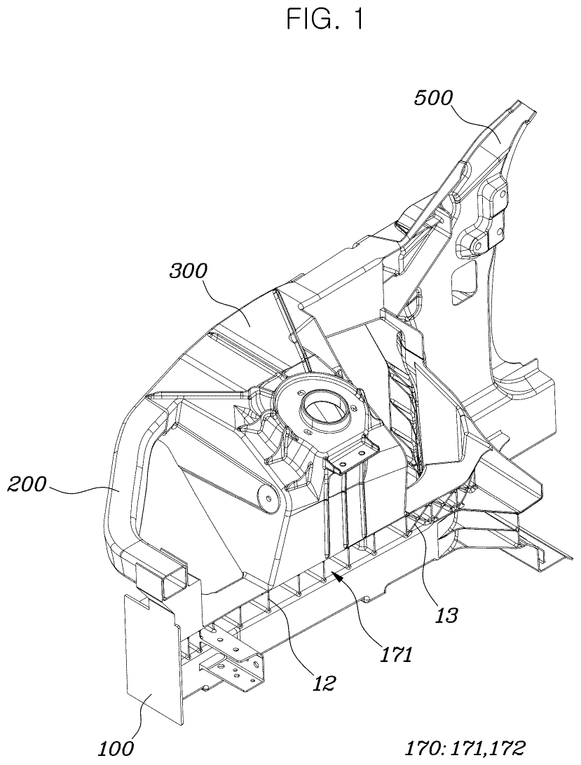

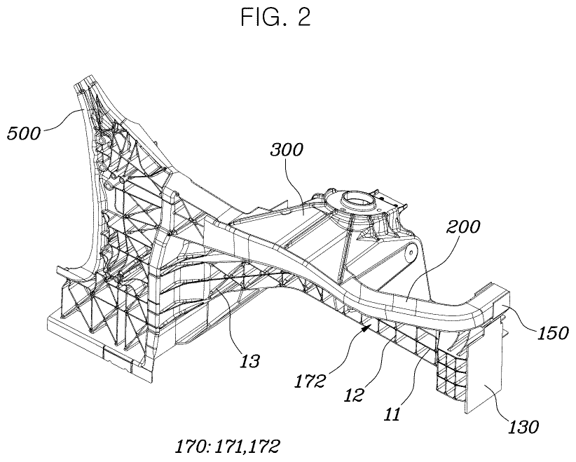

FIGS. 1 and 2 are perspective views of a front side vehicle body for a vehicle according to an embodiment of the present disclosure.

With reference to FIGS. 1 and 2, a front side vehicle body for a vehicle according to an embodiment of the present disclosure includes a front side member 100, a shock absorber housing 300, and an A-pillar 500. In particular, the front side vehicle body for a vehicle is manufactured by integrating the front side member 100, the shock absorber housing 300, and the A-pillar 500.

More specifically, the front side vehicle body for a vehicle refers to a structure located at the front side of the vehicle, extending from a front end toward a rear end of the vehicle. In the event of a frontal collision of the vehicle, the front side vehicle body may absorb a load (impact energy) and uniformly disperse the load to the entire vehicle body, thereby protecting a passenger in the vehicle from the collision, minizing the damage to the passenger.

The front side vehicle body for a vehicle may be manufactured by welding various components to the front side member, the shock absorber housing, and the A-pillar. In this process, about thirty to fifty or more components may be coupled together by welding.

A method of manufacturing the front side vehicle body for a vehicle by using welding is required to form many flanges to couple the components. This increases a weight of the front side vehicle body for a vehicle. Further, many components need to be separately manufactured, which increases the time and the number of processes required to manufacture the components.

In the present disclosure, in order to solve the above-mentioned problem, some parts of the front side vehicle body for a vehicle may be integrated, which may reduce the number of processes of welding the components and reduce the weight of the front side vehicle body for a vehicle.

In particular, the front side member 100, the shock absorber housing 300, and the A-pillar 500, which occupy a large volume of the front side vehicle body for a vehicle, are integrated.

According to this method, the front side member 100, the shock absorber housing 300, and the A-pillar 500, which occupy the large volume of the front side vehicle body for a vehicle, are integrated, which may reduce or minimize the number of welding surfaces.

The probability of fracture of the welding surface caused by a load increases as the number of welding surfaces increases. The fracture of the welding surface makes it difficult to transmit a load and concentrates an excessive load on a particular portion. For this reason, another welding surface may be fractured, which makes it difficult to perform a load dispersion.

However, the above-mentioned method of the embodiments of the present disclosure is advantageous in reducing or minimizing the number of welding surfaces and appropriately transmitting and dispersing a load (e.g., collision impact energy).

In the front side vehicle body for a vehicle according to an embodiment of the present disclosure, a left front side vehicle body and a right front side vehicle body may be provided symmetrically and connected to each other by means of a cross bar or the like. A space in the front side vehicle body may define an engine room or a space in which PE (Power Electronics) components of an electric vehicle are embedded.

In one embodiment, the front side vehicle body according to the present disclosure may be manufactured by injecting aluminum or an alloy including aluminum into a mold during a casting process. In other words, according to the present disclosure, some components, which constitute a base of the front side vehicle body for a vehicle, are integrated, such that the front side vehicle body for a vehicle is manufactured to have an opened cross-section.

In particular, the front side member 100 may have a plurality of opening portions 170 disposed in an upward/downward direction and opened in opposite directions or the same direction.

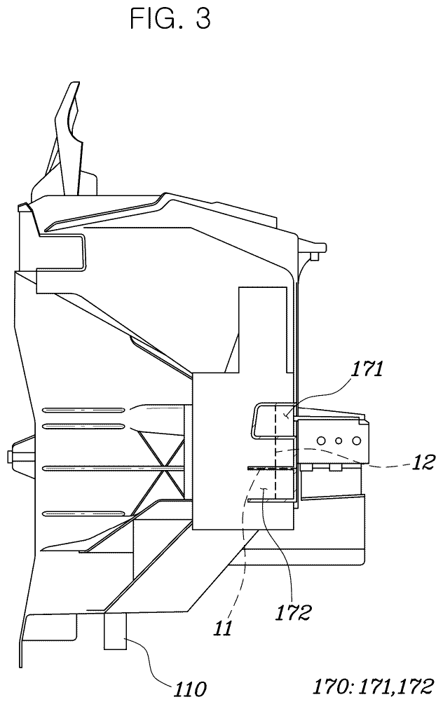

FIG. 3 is a front view illustrating the front side vehicle body for a vehicle according to one embodiment of the present disclosure and illustrating a cross-section of the front side member having the opening portion. With reference to FIGS. 1-3, the plurality of opening portions 170 may be formed in the front side member 100, and the directions in which the opening portions 170 are opened may be different from each other.

The opening portions 170 formed in the front side member 100 may have the same depths. The configuration in which the opening portions 170 have the same depths is advantageous in allowing the front side member 100 to be uniformly deformed by collapsing and crushing in the event of a frontal collision of the vehicle, allowing the front side member 100 to sufficiently absorb collision energy, and effectively transferring the collision energy to the shock absorber housing 300 and the A-pillar 500 extending from the front side member 100.

In other words, there is an advantage in that a fracture caused by concentration of stress on one point may be prevented in the event of a frontal collision of the vehicle, and the front side member 100 may be uniformly deformed and disperse a collision load to the entire vehicle while absorbing collision energy.

In this case, the opening portions 170, which are disposed in the upward/downward direction, may have the same cross-sectional area or different cross-sectional areas. However, the opening portions 170 may have the same width, and the opening portions 170, which are formed in different directions or the same directions, may allow the front side member 100 to absorb collision energy while being uniformly deformed in the event of a frontal collision of the vehicle.

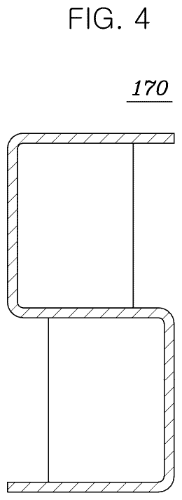

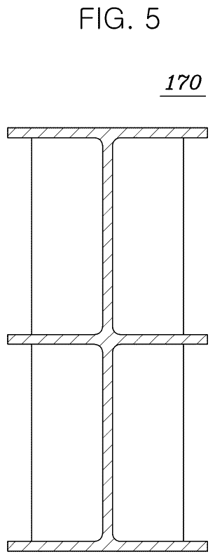

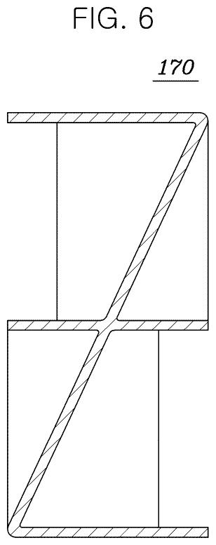

In another embodiment, the opening portions 170 may have various cross-sectional shapes. As illustrated in FIGS. 4-6, the opening portions 170, which are disposed in the upward/downward direction, may be opened in opposite directions. As illustrated in FIG. 5, the opening portions 170, which are disposed in the upward/downward direction, may be opened in the same direction, and the opening portions 170, which are disposed in a leftward/rightward direction, may be disposed in different directions.

Based on the directions in which the opening portions 170 are opened, the opening portions 170 may include one or more of first opening portions 171, which are opened toward the inside of the vehicle, and one or more of second opening portions 172 opened toward the outside of the vehicle. As illustrated in FIGS. 1-4, according to the embodiment of the present disclosure, the second opening portion 172 may be disposed below the first opening portion 171.

However, the present disclosure is not limited to the embodiment. The configuration in which the first opening portion 171 is disposed below the second opening portion 172 is also considered as being included in the protection scope of the present disclosure.

In another embodiment, a horizontal or vertical rib 11 or 12, which extends toward the inside or outside of the vehicle, may be formed in the opening portion 170 and divide the opening portion 170 into a plurality of spaces.

The horizontal rib 11 and the vertical rib 12 may intersect to define a space in the front side member 100. The horizontal rib 11 and the vertical rib 12 may effectively disperse stress applied to the vehicle body, partially absorb stress, and improve the rigidity of the front side member 100 having the opened cross-section.

In addition, the space defined by the horizontal rib 11 and the vertical rib 12 may absorb a load, which is generated by a collision, while providing a space in which the vehicle body may be deformed by the collision.

In this case, the space defined by the intersection of the horizontal rib 11 and the vertical rib 12 may be formed to be directed toward the inside or outside of the vehicle. In other words, the horizontal rib 11 and the vertical rib 12 may be formed at a left or right side of the vehicle body based on a width direction of the vehicle and define the space directed toward the inside or outside of the vehicle.

For example, as illustrated in FIGS. 1 to 4, the vertical rib 12 extending toward the inside of the vehicle may be formed in the first opening portion 171, and the horizontal and vertical ribs 11 and 12 extending toward the outside of the vehicle may be formed in the second opening portion 172.

In another embodiment, the horizontal rib 11 and the vertical rib 12 may not only be formed in the front side member 100, but also be formed in the shock absorber housing 300 or the A-pillar 500, thereby defining spaces in the corresponding components.

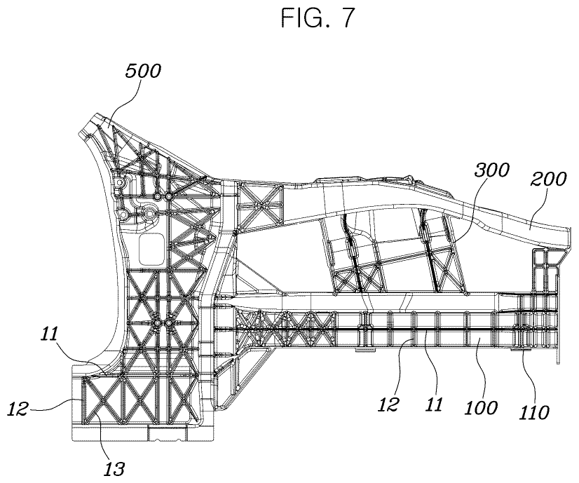

FIG. 7 illustrates an inner surface of the front side vehicle body for a vehicle according to an embodiment of the present disclosure. With reference to FIG. 7, the horizontal ribs 11 and the vertical ribs 12 may define the plurality of spaces in the front side member 100, the shock absorber housing 300, and the A-pillar 500 so that the plurality of spaces defined by the horizontal ribs 11 and the vertical ribs 12 is directed toward the outside of the vehicle.

In one embodiment, at least one diagonal rib 13, which passes through an intersection point of the horizontal rib 11 and the vertical rib 12, may be further formed in the opening portion 170, and the at least one diagonal rib 13 may divide the space defined by the horizontal rib 11 and the vertical rib 12.

Because the space defined by the horizontal rib 11 and the vertical rib 12 is additionally divided by the at least one diagonal rib 13, a cross-sectional area of the vehicle body may increase, such that the front side vehicle body for a vehicle may provide a higher rigidity.

The diagonal rib 13 provides additional regidity to the front side vehicle body such that a degree of deformation caused by a load is reduced. The sufficient deformation of the front side vehicle body for a vehicle is important to the transmission and dispersion of a load, but the continuous deformation of the vehicle body may cause a physical injury to a passenger in the vehicle. In particular, it is important to protect the passenger from a frontal collision by reducing a degree to which a vehicle body positioned to be close to the passenger is deformed.

For example, the horizontal rib 11 and the vertical rib 12 are formed at a front end of the front side member 100 relatively distant from the passenger, such that the front end of the front side member 100 may be sufficiently deformed. Therefore, a load may be effectively transmitted to the A-pillar 500 and dispersed. In this case, the front end of the front side member 100 may include a portion extending from a foremost end of the front side member 100 to a portion where the shock absorber housing is disposed.

In contrast, a portion, which is defined after the portion where the shock absorber housing 300 of the front side member 100 is disposed, is a portion where the front side vehicle body for a vehicle is positioned to be relatively close to the passenger. The need to protect the passenger from the deformation of the vehicle body by reducing a deformation degree of the vehicle body increases.

Therefore, the diagonal rib 13 is additionally formed at a rear end of the front side member 100 relatively close to the passenger, which may provide additional rigidity and further reduce the deformation degree of the vehicle body in comparison with the front end of the front side member 100, thereby avoiding or preventing the passenger from being injured by the deformation of the vehicle body.

In one embodiment, in addition to the front side member 100, the diagonal rib 13 is additionally formed in the A-pillar 500, which may prevent the passenger from being injured by the deformation of the vehicle body.

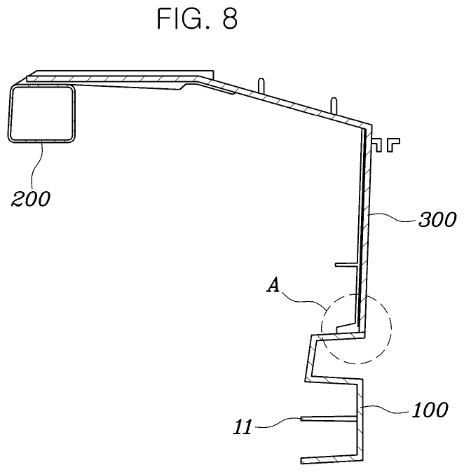

FIG. 8 is a view illustrating a state in which an end of the opening portion of the front side member and an end of a shock absorber are connected. The shock absorber housing 300 may be disposed between the front end and the rear end of the front side member 100. In particular, an end of the shock absorber housing 300 may be connected to an upper end of the opening portion 170 at the end of the front side member 100.

The shock absorber housing 300 and the front side member 100 may be integrally casted. Therefore, a load applied to the front side member 100 may be transmitted to the shock absorber housing 300. On the contrary, a load applied to the shock absorber housing 300 may be transmitted to the front side member 100.

Therefore, there is an advantage in that a load, which is consistently applied through the shock absorber housing 300 in the event of a frontal collision of the vehicle, may be effectively dispersed through the opening portion 170.

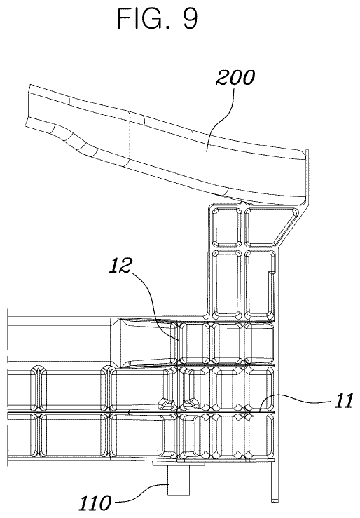

Meanwhile, in the event of a frontal collision of the vehicle, a load may be transmitted to the vehicle body through a sub-frame of the vehicle. The sub-frame is a component coupled to the front side member 100 and configured to support loads of an engine and a transmission. With reference to FIG. 9, a sub-frame mounting part 110 may be formed at the front end of the front side member 100 and coupled to the sub-frame.

In particular, the sub-frame mounting part 110 formed on the front side member 100 may be formed on the same plane as some of the vertical ribs 12 formed at the front end of the front side member. Therefore, a load, which is transmitted in a height direction of the vehicle through the sub-frame in the event of a frontal collision of the vehicle, may be transmitted to a fender apron member 200 and dispersed.

While the specific embodiments of the present disclosure have been illustrated and described, it should be obvious to those having ordinary skill in the art that the present disclosure may be variously modified and changed without departing from the technical spirit of the present disclosure defined in the appended claims.

What is claimed is:

1. A front side vehicle body for a vehicle, the front side vehicle body comprising:
a front side member extending in a longitudinal direction of the vehicle;
a shock absorber housing disposed between a front end and a rear end of the front side member and connected to the front side member; and
an A-pillar connected to the rear end of the front side member,
wherein the front side member, the shock absorber housing, and the A-pillar are integrated, and
wherein a plurality of opening portions is disposed in an upward/downward direction in the front side member and opened in opposite directions or the same direction.

2. The front side vehicle body of claim 1, wherein the plurality of opening portions has the same opening depth.

3. The front side vehicle body of claim 1, wherein the plurality of opening portions comprises:
at least one first opening portion opened toward an inside of the vehicle, and
at least one second opening portion opened toward an outside of the vehicle.

4. The front side vehicle body of claim 3, wherein the at least one second opening portion is disposed below the at least one first opening portion.

5. The front side vehicle body of claim 1, wherein at least one of a horizontal or a vertical rib, which extends toward an inside or outside of the vehicle, is formed in at least one opening portion of the plurality of opening portions and divides the at least one opening portion into a plurality of spaces.

6. The front side vehicle body of claim 5, wherein when the horizontal and the vertical rib are formed in the at least one opening portion, a diagonal rib is provided in the at least one opening portion and configured to pass through an intersection point of the horizontal rib and the vertical rib and further divide the plurality of spaces defined by the horizontal rib and the vertical rib.

7. The front side vehicle body of claim 6, wherein the horizontal rib and the vertical rib define a space at a front end of the front side member on which the shock absorber housing is disposed, and wherein the horizontal rib, the vertical rib, and the diagonal rib define a space at a rear end of the front side member.

8. The front side vehicle body of claim 5, wherein:
the plurality of opening portions comprises at least one first opening portion opened toward an inside of the vehicle, and at least one second opening portion opened toward an outside of the vehicle; and
the vertical rib extending toward the inside of the vehicle is formed in the at least one first opening portion, and the horizontal and vertical ribs extending toward the outside of the vehicle are formed in the at least one second opening portion.

9. The front side vehicle body of claim 1, wherein an end of the shock absorber housing connected to the front side member is connected to an upper end of an opening portion of the plurality of opening portions.

10. The front side vehicle body of claim 5, wherein a sub-frame mounting part, to which a sub-frame is coupled, is formed on the front side member.

11. The front side vehicle body of claim 10, wherein the sub-frame mounting part is formed on the same plane as the vertical rib formed at the front end of the front side member.

12. The front side vehicle body of claim 1, wherein the plurality of opening portions comprises:
a first opening portion opened toward an inside of the vehicle; and
a second opening portion opened toward an outside of the vehicle, and the first opening portion and the second opening portion are disposed at left and right sides of the front side vehicle body.
